(19) United States
(12) Patent Application Publication
(10) Pub. No.: US 2015/0197834 A1
(43) Pub. Date: Jul. 16, 2015

(54) Ag-Pd-Cu-Co ALLOY FOR USES IN ELECTRICAL/ELECTRONIC DEVICES

(71) Applicant: Takuriki Honten Co., Ltd., Tokyo (JP)

(72) Inventors: Hideo Kumita, Tokyo (JP); Ryu Shishino, Tokyo (JP); Keiju Uruu, Tokyo (JP)

(21) Appl. No.: 14/670,937

(22) Filed: Mar. 27, 2015

Related U.S. Application Data
(63) Continuation of application No. PCT/JP12/75253, filed on Sep. 28, 2012.

(51) Int. Cl. C22C 30/06; C22C 30/04; H01B 1/02; C22C 5/06; C22C 5/04; C22C 9/00; C22C 30/02; C22C 5/08

(52) U.S. Cl. CPC C22C 30/06; C22C 30/02; C22C 30/04; C22C 5/08; C22C 5/06; C22C 5/04; C22C 9/00; H01B 1/02; H01B 1/026

(57) ABSTRACT

The present invention is to provide metal material for electric/electronic devices, which is comprised of 20 to 50 mass % of Ag or 20 to 50 mass % of Pd to 10 to 40 mass % of Cu, 5 to 30 mass % of Co, said alloy has low contact resistance, good oxidation resistance, high hardness, good workability, and low wettability and anti-erosion property to Sn alloy solder.

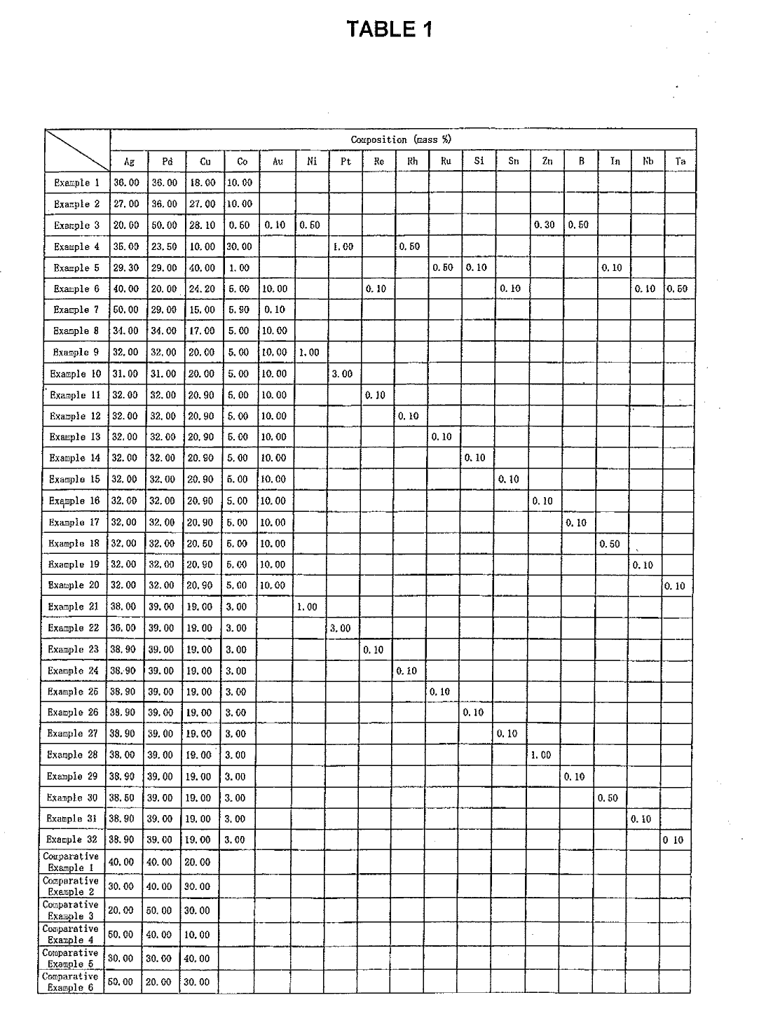

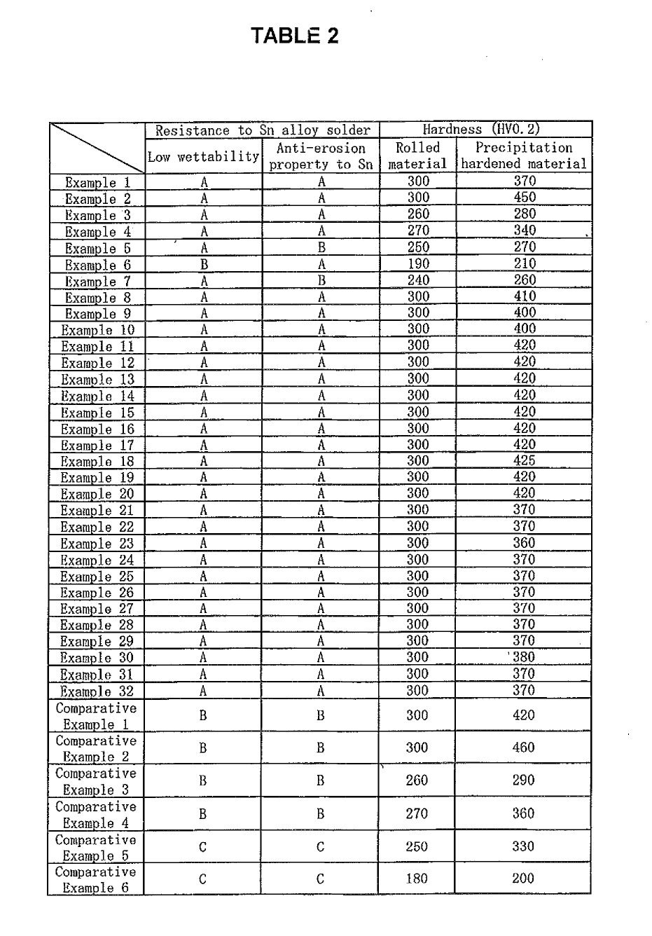

### TECHNICAL FIELD

The present invention relates to a metal material for use in electric/electronic devices.

### BACKGROUND ART

For a metal material used in electric/electronic devices, various properties such as low contact resistance and good oxidation resistance are required, and therefore, expensive noble metal alloys such as a Pt alloy, an Au alloy, a Pd alloy and an Ag alloy are widely used. In addition, depending on the intended use (for example, an inspection probe for a semiconductor integrated circuit and the like), hardness (abrasive resistance) and the like are also required in addition to the low contact resistance and the oxidation resistance. Accordingly, a Pt alloy, an Ir alloy and the like which show high hardness in the state of having been subjected to plastic working and an Au alloy, a Pd alloy and the like which are subjected to precipitation hardening, have been preferably used (for example, see Patent Literature 1 and Patent Literature 2).

### CITATION LIST

### Patent Literature

[Patent Literature 1] JP 4176133 B
[Patent Literature 2] JP 4216823 B
[Patent Literature 3] WO 2007/034921

In particular, with regard to an inspection probe for a semiconductor integrated circuit and the like (hereinafter, referred to as a probe), a wide variety of types (shapes) such as a cantilever, a Cobra, a spring and the like are employed depending on an inspection subject, and the desired properties also vary depending on the type of each of probes, respectively.

### SUMMARY OF INVENTION

### Technical Problem

When an inspection subject of a probe is an Sn alloy solder bump or the like, and when a material of the probe has a low anti-erosion property and high wettability to Sn which is contained in the Sn alloy solder, the Sn alloy solder tends to adhere to the probe during operation tests repeated several tens of thousand times, and as a result, a resistance value tends to be changed, which may result in the inability to perform accurate tests.

Accordingly, as a countermeasure against the adhesion of the Sn alloy solder to the probe, the tip of a probe has been washed after conducting a certain times of tests. However, if it is possible that Sn alloy solder is hardly adhered to a probe, washing times can be reduced and, in addition, more accurate tests can be performed and a yield ratio of a test can also be improved.

To satisfy these demands, research and development have been conducted by, for example, carrying out Ag plating, Pd plating and the like. However, since operation tests, washing and the like are repeated several tens of thousand times, there is concern over the abrasion of plating and the like. In addition, with microminiaturization of inspection subjects of recent years, microminiaturization of probe itself has been proceeded, and therefore, there may be some cases where plating is difficult to carry out (for example, see Patent Literature 3).

### Solution to Problem

The present invention provides an Ag—Pd—Cu—Co alloy for electric/electronic devices which has low wettability as well as anti-erosion property to Sn which is a main component of Sn alloy solder, by adding 0.5 to 30 mass % of Co, which is a specific element, to an Ag—Pd—Cu alloy composed of 20 to 50 mass % of Ag, 20 to 50 mass % of Pd and 10 to 40 mass % of Cu. Meanwhile, in the present invention, Sn alloy solder refers to Pb-free solder of which representative examples include Sn—Cu series solder, Sn—Ag series solder, Sn—Ag—Cu series solder, Sn—Zn—Bi series solder, Sn—Ag—In series solder, Sn—Zn—Al series solder and the like.

In the present invention, the reason why the addition amount of Co is 0.5 to 30 mass % is to obtain low wettability to Sn alloy solder and to improve anti-erosion property to Sn alloy solder. When the addition amount is less than 0.5 mass %, the effects of anti-erosion property and low wettability to Sn alloy solder tend not to be exhibited, and when the addition amount exceeds 30 mass %, workability tends to be markedly decreased, and further, the desired hardness tends not to be achieved.

In addition, one feature is to add 0.1 to 10 mass % of Au and/or 0.1 to 3.0 mass % of at least one additive element selected from the group consisting of Ni, Pt, Re, Rh, Ru, Si, Sn, Zn, B, In, Nb and Ta, as an additive element which improves the property of an alloy depending on the intended use, to the alloy of the present invention which is an Ag—Pd—Cu alloy to which Co is added. The reason why adding 0.1 to 10 mass % of Au is to improve oxidation resistance and hardness of the alloy. When the addition amount of Au is less than 0.1 mass %, the desired effect tends not to be exhibited, and when the addition amount of Au exceeds 10 mass %, workability of the alloy tends to be impaired. The reason why adding 0.1 to 3.0 mass % of at least one additive element selected from the group consisting of Ni, Pt, Re, Rh, Ru, Si, Sn, Zn, B, In, Nb and Ta is to improve hardness of the alloy. Ni also acts as an additive element which improves bending characteristics after precipitation of an Ag—Pd—Cu alloy. Re, Rh and Ru also act as an additive element which micronizes crystal grains.

### Advantageous Effects of Invention

The present invention makes it possible to provide a metal material for use in electric/electronic devices which has low contact resistance, good oxidation resistance, high hardness, good workability as well as low wettability and anti-erosion property to Sn alloy solder.

### DESCRIPTION OF EMBODIMENTS

The present invention is hereinafter described by Examples. An ingot (thickness: 10 mm×width: 10 mm×length: 100 mm) of an alloy, which was obtained by adding Co or an additive element which improves properties depending on the intended use to each Ag—Pd—Cu alloy, was manufactured by vacuum melting.

After removing defects in melting such as shrinkage cavities, rolling processing and solution heat treatment (800° C., for one hour, in mixed atmosphere of H₂ and N₂) were repeated until the thickness of plate became 0.3 mm, and the plate which had been subjected to rolling processing until the final reduction in area became about 75% was used as a test piece (thickness: 0.3 mm×width: 20 mm×length: 20 mm), and precipitation hardening was conducted under the conditions of 300 to 500° C. for one hour in mixed atmosphere of H₂ and N₂. In addition, with regard to the measurement of hardness of the test piece, surface hardness was measured by using a Vickers hardness testing machine with HV 0.2.

Lowness of wettability to Sn alloy solder and anti-erosion property to Sn alloy solder were examined as follows: a piece of Sn alloy solder with thickness of 0.8 mm×width of 1.0 mm×length of 10 mm was placed on the test piece, and was heated to 275° C. and was held at this temperature for one minute, and then the melted Sn alloy solder was cooled, and thereafter, the appearance of the test piece was observed to evaluate lowness of wettability to Sn alloy solder. The evaluation criteria of lowness of wettability was as follows: the test piece with a width of melted Sn alloy solder of less than 3.0 mm was rank A, the test piece with a width of melted Sn alloy solder of 3.0 mm to 4.9 mm was rank B, and the test piece with a width of melted Sn alloy solder of 5.0 mm or more was rank C. In addition, by observing sectional metallographic structure of the test piece and Sn alloy solder, anti-erosion property to Sn alloy solder was evaluated. The evaluation criteria of anti-erosion property to Sn alloy solder was as follows: the test piece with an erosion depth of Sn to the test piece of less than 30 μm was rank A, the test piece with an erosion depth of Sn to the test piece of 30-59 μm was rank B, and the test piece with an erosion depth of Sn to the test piece of 60 μm or more was rank C.

In Examples of the present invention, vacuum melting was employed as a melting method, but the present invention can be applied to various metal melting methods other than vacuum melting, such as a continuous casting method, a gas melting method and the like. Further, it is expected that the material of the present invention can also be melted by a novel melting method which will be established in future.

In Examples of the present invention, a plate material was manufactured as a test piece, and therefore, the test piece was subjected to rolling processing which is one of methods for plastic working, but various methods for plastic working other than rolling processing can be employed depending on the desired shape. For example, when the desired shape is wire, plastic workings such as wire drawing (drawing process), swaging working and the like are suitable, and such plastic workings can be suitably used for a metal material for probe and the like which is used for manufacturing a probe. Further, it is expected that the material of the present invention can also be worked by a novel plastic working method which will be established in future.

The Sn alloy solder used in Examples of the present invention was ECO SOLDER (a registered trademark) (Sn—Ag—Cu series) manufactured by Senju Metal Industry Co., Ltd., but when other Pb-free solder (Sn alloy solder) was used, low wettability and improvement of anti-erosion property to Sn alloy solder were also confirmed.

Table 1 and Table 2 show lists of compositions of Examples, lowness of wettability, anti-erosion property to Sn alloy solder, as well as hardness after processing and that after precipitation hardening.

As shown in results on Table 2, with regard to Comparative Example 1 and Comparative Example 2 in which Co was not added to Ag—Pd—Cu, both lowness of wettability and anti-erosion property to Sn alloy solder were rank B, but with regard to Example 1 and Example 2, which were Examples in which 10 mass % of Co was added to Comparative Example 1 and Comparative Example 2, respectively, the improvement of both lowness of wettability and anti-erosion property to Sn alloy solder was confirmed, and both lowness of wettability and anti-erosion property to Sn alloy solder were rank A.

Similarly, with regard to Comparative Examples 3 to 6, there were no cases where even either lowness of wettability or anti-erosion property to Sn alloy solder was rank A. With regard to Examples 3-32, which were Examples of Ag—Pd—Cu alloys to which Co was added, and to which at least one selected from the group consisting of Au, Ni, Pt, Re, Rh, Ru, Si, Sn, Zn, B, In, Nb and Ta was further added, at least one of lowness of wettability and anti-erosion property to Sn alloy solder was rank A, and there were no Examples which showed rank C, and therefore, low wettability to Sn alloy solder and the improvement of anti-erosion property to Sn alloy solder could be confirmed.

What is claimed is:

1. A metal material for use in an electric/electronic device, the metal material comprising an alloy which contains 20 to 50 mass % of Ag, 20 to 50 mass % of Pd, 10 to 40 mass % of Cu and 0.5 to 30 mass % of Co, in which the metal material has low wettability to Sn alloy solder and anti-erosion property to Sn alloy solder.

2. The metal material according to claim 1, wherein the alloy further comprises 0.1 to 10 mass % of Au.

3. The metal material according to claim 1 or claim 2, wherein the alloy further comprises 0.1 to 3.0 mass % of at least one additive element selected from the group consisting of Ni, Pt, Re, Rh, Ru, Si, Sn, Zn, B, In, Nb and Ta.

4. The metal material according to claim 1 or claim 2, which has a hardness of 200-450 HV after being subjected to plastic working and at the time of precipitation hardening.

5. The metal material according to claim 3, which has a hardness of 200-450 HV after being subjected to plastic working and at the time of precipitation hardening.
